(19) United States
(12) Patent Application Publication
(10) Pub. No.: US 2011/0298898 A1
(43) Pub. Date: Dec. 8, 2011

(54) THREE DIMENSIONAL IMAGE GENERATING SYSTEM AND METHOD ACCOMODATING MULTI-VIEW IMAGING

(75) Inventors: Yong Ju Jung, Daejeon (KR); Haitao Wang, Beijing (CN); Ji Won Kim, Seoul (KR); Gengyu Ma, Beijing (CN); Xing Mei, Beijing (CN); Du Sik Park, Suwon-si (KR)

(73) Assignee: SAMSUNG ELECTRONICS CO., LTD., Suwon-si (KR)

(21) Appl. No.: 13/100,905

(22) Filed: May 4, 2011

(30) Foreign Application Priority Data
May 11, 2010 (KR) 10-2010-0043858

(51) Int. Cl. H04N 13/02

(52) U.S. Cl. 348/47; 348/E13.074

(57) ABSTRACT

Provided is a three-dimensional (3D) image generating system and method accommodating multi-view imaging. The 3D image generating system and method may generate corrected depth maps respectively corresponding to color images by merging disparity information associated with a disparity between color images and depth maps generated respectively from depth images.

### CROSS-REFERENCE TO RELATED APPLICATIONS

This application claims the priority benefit of Korean Patent Application No. 10-2010-0043858, filed on May 11, 2010, in the Korean Intellectual Property Office, the disclosure of which is incorporated herein by reference.

### BACKGROUND

1. Field

One or more embodiments relate to a three-dimensional (3D) image generating and system and method, and more particularly, to a 3D image generating system and method that may obtain depth information to generate a multi-view image, while capturing a 3D image.

2. Description of the Related Art

Recently, demand for three-dimensional (3D) images that allow users to view TV, movies, and the like, in 3D space has been rapidly increasing. In particular, as the digital broadcasting is widely used, various studies associated with 3D images have been conducted in fields, such as with a 3D TV, a 3D information terminal, and the like.

In general, a view difference may be used to embody a 3D image, and a view difference-based scheme may be classified into a stereoscopic scheme and an autostereoscopic scheme depending on whether glasses are used. A view difference may include different views of the same object(s) or scene, for example. The stereoscopic scheme may be classified into a polarizing glasses scheme and a liquid crystal shutter glasses scheme. The autostereoscopic scheme may use a lenticular lens scheme, a parallax barrier scheme, and a parallax illumination scheme, and the like.

The stereoscopic scheme may provide a stereoscopic effect with two images, using polarizing glasses. The autostereoscopic scheme may provide a stereoscopic effect with two images based on a location of a viewer and thus, may need a multi-view image.

To obtain the multi-view image for autostereoscopic multi-view display, images may be obtained from multiple cameras arranged at multiple points of view. For example, the multiple cameras may be arranged in the horizontal direction.

However, when image data is captured from each of multiple view points, e.g., points of view, multiple cameras may be used and an amount of data to be transmitted may increase and be undesirably large.

### SUMMARY

One or more embodiments relate to a three-dimensional (3D) image generating and/or displaying system and method that may obtain depth information to generate a multi-view image, while capturing a 3D image.

The foregoing problems may be over come and/or other aspects may be achieved by a three-dimensional (3D) image generating system for a multi-view image, the system including stereo color cameras to capture stereo color images for a 3D image, stereo depth cameras to capture depth images of areas same as areas photographed by the stereo color cameras, a mapping unit to map the captured depth images with respective corresponding color images, of the captured color images, and a depth merging unit to generate corrected depth maps respectively corresponding to the captured color images, based on both disparity information associated with a disparity between the captured color images and primary depth maps respectively generated by the mapping of the mapping unit from the captured depth images.

The depth merging unit may include a first depth measuring unit to generate the primary depth maps respectively from the captured depth images, a second depth measuring unit to generate secondary depth maps respectively corresponding to the captured color images, based on the disparity information, and a weighted-average calculator to generate the corrected depth maps by weighted-averaging, using a predetermined weight, the primary depth maps and the secondary depth maps respectively corresponding to the captured color images.

The depth merging unit may include a first depth measuring unit to generate the primary depth maps respectively from the captured depth images, and a second depth measuring unit to use information associated with the primary depth maps as a factor to calculate a disparity distance between the captured color images when stereo-matching of the captured color images is performed to generate the corrected depth maps.

The system may further include a synchronizing unit to set the stereo color cameras to be synchronized with the stereo depth cameras.

The system may still further include a camera setting unit to determine a feature of each of the stereo color cameras and the stereo depth cameras, to set the stereo color cameras and the stereo depth cameras to respectively capture the color images and the depth images with a same size, and to set the stereo depth cameras to respectively capture same respective areas as areas captured by respective corresponding stereo color cameras.

The system may include a distortion correcting unit to correct a distortion that occurs in the captured color images and the captured depth images due to a feature of each of the stereo color cameras and the stereo depth cameras, a stereo correcting unit to correct an error that occurs when the stereo color cameras and the stereo depth cameras perform capturing in different directions, a color correcting unit to correct a color error in the captured color images, which occurs due to a feature of each of the stereo color cameras being different, and/or a 3D image file generating unit to generate a 3D image file including the captured color images and the corrected depth maps.

The generating of the 3D image file may include generating confidence maps to indicate respective confidences of the corrected depth maps.

The foregoing problems may be over come and/or other aspects may be achieved by a three-dimensional (3D) image generating method for a multi-view image, the method including receiving color images and depth images respectively captured from stereo color cameras and stereo depth cameras, mapping the captured depth images with respective corresponding color images, of the captured color images, and generating corrected depth maps respectively corresponding to the captured color images, based on both disparity information associated with a disparity between the captured color images and primary depth maps respectively generated from the mapping of the captured depth images.

The generating of the corrected depth maps may include generating the primary depth maps respectively from the captured depth images, generating secondary depth maps respectively corresponding to the captured color images, based on the disparity information, and generating the corrected depth maps by weighted-averaging, using a predetermined weight, the primary depth maps and the secondary depth maps respectively corresponding to the captured color images. The generating of the corrected depth maps may include generating the primary depth maps respectively from the captured depth images, and generating the corrected depth maps, using information associated with the primary depth maps as a factor to calculate a disparity distance between the captured color images when stereo-matching of the captured color images is performed to generate the corrected depth maps.

The method may further include setting the stereo color cameras to be synchronized with the stereo depth cameras. The method may further include determining a feature of each of the stereo color cameras and the stereo depth cameras, to set the stereo color cameras and the stereo depth cameras to capture the color images and the depth images with a same size, and to set the stereo depth cameras to respectively capture same respective areas as areas captured by respective corresponding stereo color cameras. The method may still further include correcting a distortion that occurs in the captured color images and the captured depth images due to a feature of each of the stereo color cameras and the stereo depth cameras, correcting an error that occurs when the stereo color cameras and the stereo depth camera perform capturing in different directions, correcting a color error in captured color images, which occurs due to a feature of each of the stereo color cameras being different, and/or generating a 3D image file including the captured color images and the corrected depth maps.

The 3D image may file further include confidence maps to indicate respective confidences of the corrected depth maps.

Additional aspects of embodiments will be set forth in part in the description which follows and, in part, will be apparent from the description, or may be learned by practice of one or more embodiments of disclosure. One or more embodiments are inclusive of such additional aspects

### BRIEF DESCRIPTION OF THE DRAWINGS

These and/or other aspects will become apparent and more readily appreciated from the following description of embodiments, taken in conjunction with the accompanying drawings of which:

FIG. 1 illustrates a configuration of a system of providing a multi-view three-dimensional (3D) image, according to an one or more embodiments;

FIG. 2 illustrates a configuration of a 3D image generating unit, according to one or more embodiments;

FIG. 3 illustrates a configuration of a depth merging unit, according to one or more embodiments;

FIG. 4 illustrates a configuration of a depth merging unit, according to one or more embodiments;

FIG. 5 illustrates a configuration of a 3D image file including depth information, according to one or more embodiments; and

FIG. 6 illustrates a process where a 3D image generating system for a multi-view image generates a 3D image, according to one or more embodiments.

### DETAILED DESCRIPTION

Reference will now be made in detail to one or more embodiments, illustrated in the accompanying drawings, wherein like reference numerals refer to like elements throughout. In this regard, embodiments of the present invention may be embodied in many different forms and should not be construed as being limited to embodiments set forth herein. Accordingly, embodiments are merely described below, by referring to the figures, to explain aspects of the present invention.

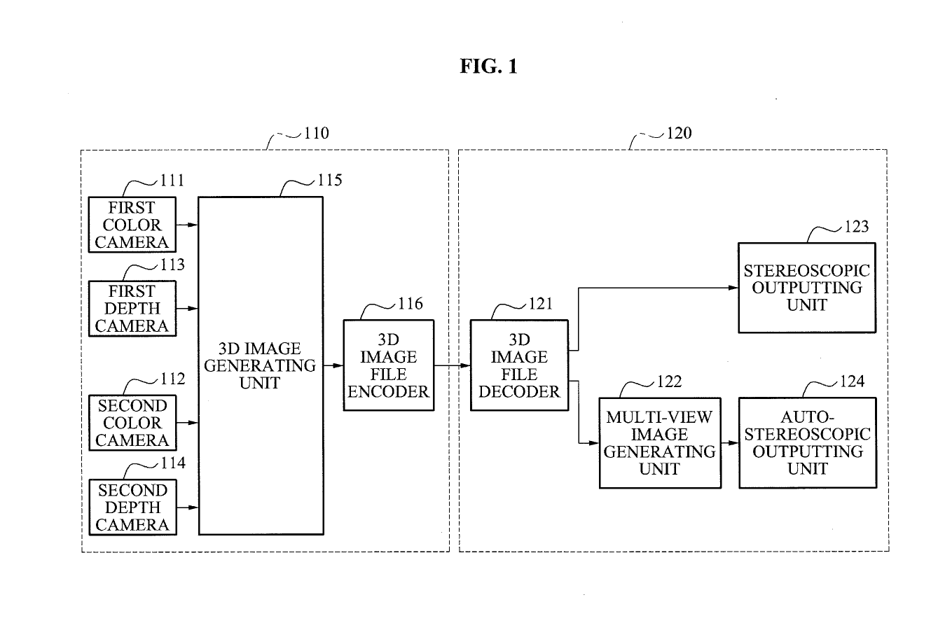

FIG. 1 illustrates a configuration of a system of providing a multi-view three-dimensional (3D) image, according to one or more embodiments.

Referring to FIG. 1, the system providing the 3D image may include a 3D image generating system 100 generating a 3D image and a 3D image displaying system 120. In one or more embodiments, the 3D image generating system 100 and the 3D image displaying system 120 may also be included in a same system or a single device, and the 3D image generating system 100 of FIG. 1 may further forward the generated encoded 3D image to a 3D image displaying system 120 in a different system or device, and the 3D image displaying system 120 of FIG. 1 may receive an encoded 3D image from a 3D image generating system 100 in such a different system or device.

The 3D image generating system 100 may generate the 3D image including depth information. The 3D image generating system 110 may include a first color camera 111, a second color camera 112, a first depth camera 113, a second depth camera 114, a 3D image generating unit 115, and a 3D image file encoder 116, for example.

The first color camera 111 and the second color camera 112 may be stereo color cameras that capture two-dimensional (2D) images for the 3D image. The stereo color cameras may be color cameras capturing image data in the same direction separated by a predetermined distance, which capture, in stereo, two 2D images for the 3D image. In an embodiment, the same directions may be parallel directions. In an embodiment, the predetermined distance may be a distance between two eyes of a person, noting that alternatives are also available.

The first depth camera 113 and the second depth camera 114 may be stereo depth cameras capturing depth images in stereo. A depth image may indicate a distance to a captured subject. The first depth camera 113 and the first color camera 111 may capture image data for the same area, and the second depth camera 114 and the second color camera 112 may capture respective image data for the same area. The first depth camera 113 and the first color camera 111 may capture respective image data in the same direction, and the second depth camera 114 and the second color camera 112 may capture respective image data in the same direction. In an embodiment, each of the first depth camera 113 and the second depth camera 114 may output a confidence map showing a confidence for each pixel of a corresponding captured depth image.

The stereo depth cameras 113 and 114 may be depth cameras capturing depth image data in the same direction separated by a predetermined distance, which capture, in stereo, two depth images for the multi-view 3D image. In this example, the predetermined distance may be a distance between two eyes of a person, noting that alternatives are also available.

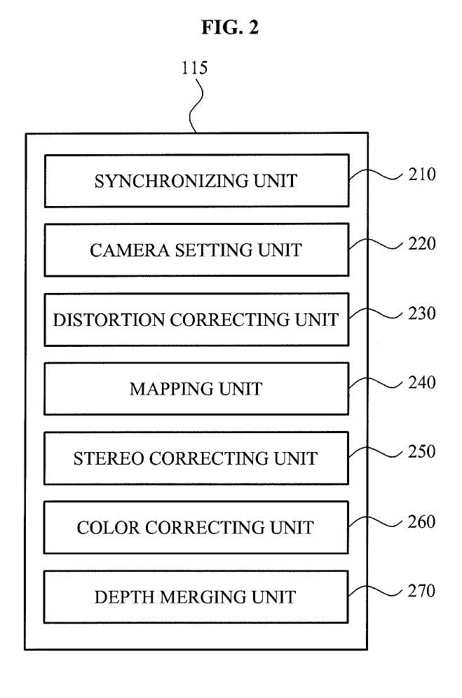

The 3D image generating unit 115 may generate a corrected depth map using depth images and color images respectively captured by the stereo depth cameras 113 and 114 and the stereo color cameras 111 and 112. Such a 3D image generating unit 115 will be described with reference to FIG. 2.

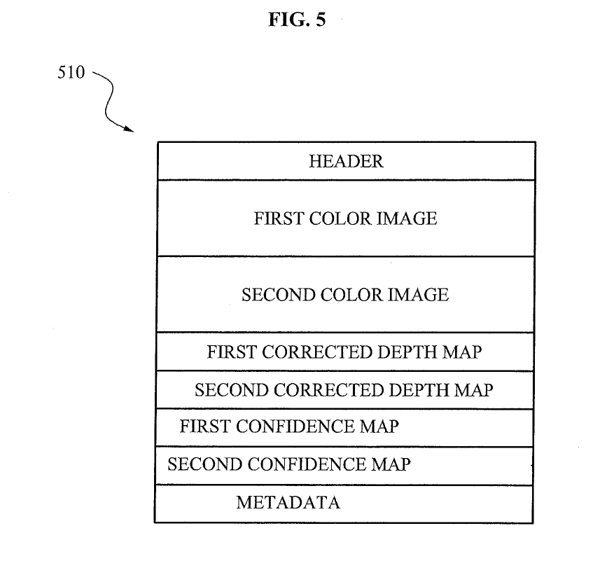

The 3D image file encoder 116 may generate a 3D image file including the color images and the corrected depth maps, and/or a corresponding bitstream. In one or more embodiments, the 3D image file or bitstream may be provided to or transmitted to the displaying device 120. The 3D image file may be configured as shown in FIG. 5.

Briefly, FIG. 5 illustrates a configuration of a 3D image file 510 and/or corresponding bitstream including depth information, according to one or more embodiments.

Referring to FIG. 5, as only an example, the 3D image file 510 may include a header, a first color image, a second color image, a first corrected depth map, a second corrected depth map, a first confidence map, a second confidence map, and metadata. As only a further example and depending on embodiment, the first confidence map, the second confidence map, or metadata may be omitted. Accordingly, in an embodiment, the 3D image file 510 is configured so a 3D image displaying system is capable of, based on the 3D image file 510, displaying a stereoscopic image and autostereoscopic multi-view images, e.g., with the respective stereoscopic outputting unit 123 and autostereoscopic outputting unit 124 of FIG. 1.

Referring back to FIG. 1, the first color image may be an image captured by the first color camera 111, the second color image may be an image captured by the second color camera 112, the first corrected depth map may be a depth map corresponding to the first color image, and the second corrected depth map may be a depth map corresponding to the second color image.

Depending on embodiment, the third image file 510 may include a first corrected disparity map and a second corrected disparity map, as opposed to the first corrected depth map and the second corrected depth map.

The third image displaying system 120 may receive a 3D image file 510 generated by a 3D image generating system 110, for example, and may output the received 3D image file as a stereoscopic 3D image or an autostereoscopic multi-view 3D image. The 3D image displaying system 120 may include a 3D image file decoder 121, a multi-view image generating unit 122, a stereoscopic outputting unit 123, and an autostereoscopic outputting unit 124, for example.

The 3D image file decoder 121 may decode the 3D image file 510 to extract and decode color images and depth maps.

The stereoscopic outputting unit 123 may output the decoded color images to display a 3D image.

The multi-view image generating unit 122 may generate, with the decoded color images, a multi-view 3D image, using the decoded depth maps. The autostereoscopic outputting unit 124 may display the generated multi-view 3D image generated based on the decoded depth maps.

FIG. 2 illustrates a configuration of a 3D image generating unit, such as the 3D image generating unit of FIG. 1, according to one or more embodiments.

Referring to FIG. 2, the 3D image generating unit 115 may include a synchronizing unit 210, a camera setting unit 220, a distortion correcting unit 230, a mapping unit 240, a stereo correcting unit 250, a color correcting unit 260, and a depth merging unit 270, for example.

The synchronizing unit 210 may set the stereo color cameras 111 and 112 to be synchronized with the stereo depth cameras 113 and 114.

The camera setting unit 220 may identify a feature of each of the stereo color cameras 111 and 112 and the stereo depth cameras 113 and 114, and may set the stereo color cameras and the stereo depth cameras to be the same. The setting of the stereo color cameras and the stereo depth cameras to be the same may include setting the stereo color cameras 111 and 112 and the stereo depth cameras 113 and 114 to capture image data in the same direction. The setting of the stereo color cameras and the stereo depth cameras to be the same may additionally or alternatively include setting of stereo color cameras 111 and 112 and the stereo depth cameras 113 and 114 to capture color images and depth images with the same size, e.g., with same resolutions. The setting of the stereo color cameras and the stereo depth cameras to be the same may additionally or alternatively include setting the stereo color camera 111 and the stereo depth camera 113 corresponding to the stereo color camera 111 to capture image data of a same area, and setting the stereo color camera 112 and the stereo depth camera 114 corresponding to the stereo color camera 112 to capture image data of a same area. The camera setting unit 220 may implement one or more of these settings once prior to beginning image capturing, for example.

The distortion correcting unit 230 may correct a distortion that occurs in the color images and the depth images due to a feature of each of the stereo color cameras 111 and 112 and the stereo depth cameras 113 and 114.

The distortion correcting unit 230 may correct a distortion in confidence maps generated by the stereo depth cameras 113 and 114.

The mapping unit 240 may map the depth images with respective corresponding color images and thus, the mapping unit 240 may calculate a depth value (Z) that corresponds to a 2D image point (x, y) corresponding to each of pixels in the color images. In an embodiment, a size of a depth image may not be identical with a size of a color image. In general, the color images have a higher definition than the depth images, and in this case, the mapping unit 240 may perform mapping by upsampling of the depth images. The upsampling may be performed in various schemes, and examples of the upsampling may include an interpolation scheme and an inpainting scheme that also factors in a feature of a corresponding color image, noting that alternative upsampling schemes are also available.

The stereo correcting unit 250 may correct errors that occur when the stereo depth camera 113 and the stereo depth camera 114 capture image data in different directions.

The color correcting unit 260 may correct a color error between the color images, which may occur due to respective features, e.g., physical differences or setting differences, of each of the stereo color cameras 113 and 114.

The color error may indicate that a color of captured image data should actually be a different color, or that colors of captured image data that are initially seen as being the same color are actually different colors due to feature of each of the stereo depth cameras 113 and 114.

The depth merging unit 270 may generate corrected depth maps respectively corresponding to the color images based on both disparity information associated with a disparity between the color images and primary depth maps generated respectively from the depth images.

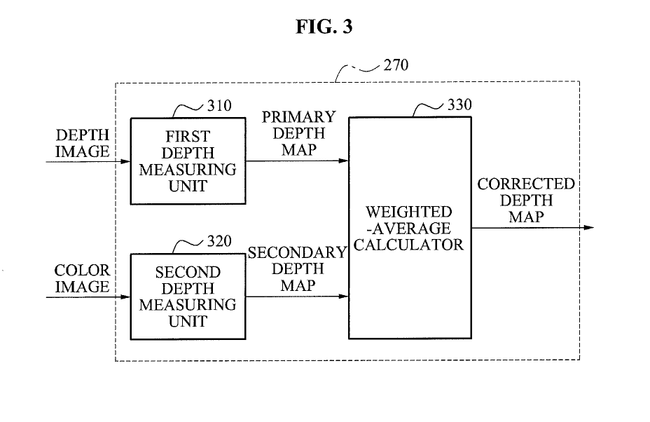

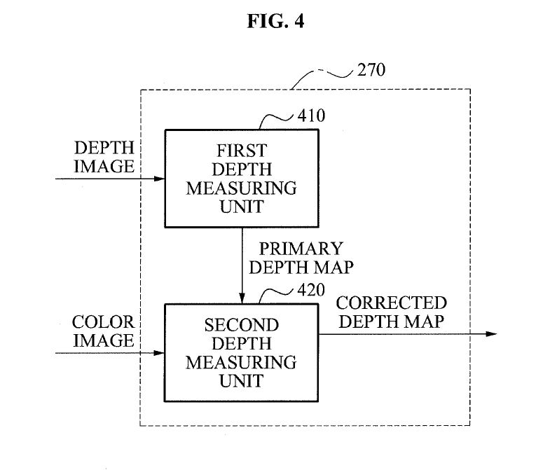

One or more methods where such a depth merging unit generating the corrected depth maps will be described with reference to FIGS. 3 and 4, according to one or more embodiments. Below, though references may be made to FIG. 2, one or more embodiments respectively supported by FIGS. 3 and 4 are not limited to the configuration and operation demonstrated by FIG. 2.

FIG. 3 illustrates a configuration of a depth merging unit, such as the depth merging unit 270 of FIG. 2, according to one or more embodiments.

Referring to FIG. 3, the depth merging unit 270 may include a first depth measuring unit 310, a second depth measuring unit 320, and a weighted-average calculator 330, for example.

The first depth measuring unit 310 may generate the primary depth maps respectively from the depth images.

The second depth measuring unit 320 may generate secondary depth maps respectively corresponding to the color images, e.g., based on the disparity information associated with the disparity between the color images.

The weighted-average calculator 330 may generate the corrected depth maps by weighted-averaging, using a predetermined weight, the primary depth maps and secondary depth maps respectively corresponding to the color images.

FIG. 4 illustrates a configuration of a depth merging unit, such as the depth merging unit 270 of FIG. 2, according to one or more embodiments.

Referring to FIG. 4, the depth merging unit 270 may include a first depth measuring unit 410 and a second depth measuring unit 420, for example.

The first depth measuring unit 410 may generate the primary depth maps respectively from the depth images.

The second depth measuring unit 420 may use information associated with the primary depth maps as a factor to calculate the disparity distance between the color images when stereo-matching of the color images is performed to generate the corrected depth maps.

For example, in one or more embodiments, when the stereo-matching is performed based on a Markov random field (MRF) model, the second depth measuring unit 420 may calculate the disparity distance by the below Equation 1, for example, using the information associated with the primary depth maps and thus, may calculate the disparity distance as expressed by the below Equation 2 or Equation 3, also only as examples.

E=E_{data}+Eₛₘₒₒₜₕ Equation 1

In Equation 1, E may denote the disparity distance between the color images, E_{data} may denote a data term that indicates a matching cost, such as a difference in color value between corresponding pixels and the like, Eₛₘₒₒₜₕ may denote a cost expended for imposing a constraint that changes a disparity between adjacent pixels to be smooth.

E=E_{data}+Eₛₘₒₒₜₕ+E_{depth} Equation 2

In Equation 2, E may denote the disparity distance between color images, E_{data} may denote a data term that indicates a matching cost, such as a difference in color value between corresponding pixels and the like, Eₛₘₒₒₜₕ may denote a cost expended for imposing a constraint that changes a disparity between adjacent pixels to be smooth, and E_{depth} may denote information associated with a corresponding pixel in the primary depth maps.

E=Eₛₘₒₒₜₕ+E_{depth} Equation 3

In Equation 3, E may denote the disparity distance between color images, Eₛₘₒₒₜₕ may denote a cost expended for imposing a constraint that changes a disparity between adjacent pixels to be smooth, and E_{depth} may denote information associated with a corresponding pixel in the primary depth maps.

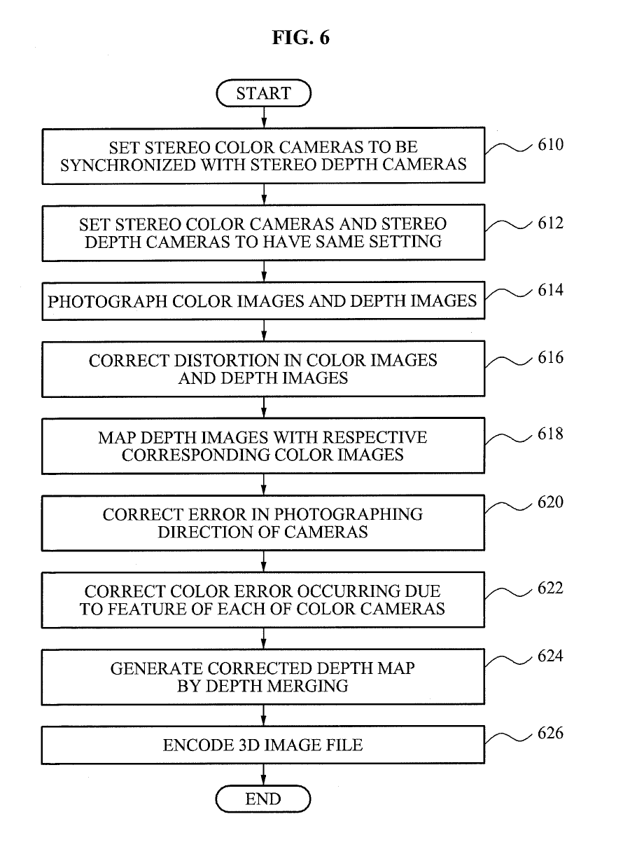

A 3D image generating method for a multi-view image will be described below with reference to FIG. 6.

FIG. 6 illustrates a 3D generating process, according to one or more embodiments. As only an example, the 3D generating process may be implemented by a 3D image generating system, such as shown in FIG. 1.

Referring to FIG. 6, stereo color cameras are set to be synchronized with stereo depth cameras, in operation 610.

One or more features of each of the stereo color cameras and the stereo depth cameras are identified or determined, and the stereo color cameras and the stereo depth cameras are set to have the same settings, in operation 612. In an embodiment the same setting may include setting of stereo color cameras and the stereo depth cameras to capture color images and depth images with the same size. The same setting may include setting the stereo depth cameras to respectively capture image data for the same areas captured by respective corresponding stereo color cameras. In an embodiment, the camera setting in operation 612 may be performed once prior to beginning image capturing, for example.

Capturing of color images and depth images is performed using the stereo color cameras and the stereo depth cameras, in operation 614.

Correction of a distortion occurring in the color images and the depth images is performed due to one or more features of each of the stereo color cameras and the stereo depth cameras, in operation 616.

The depth images are mapped with respective corresponding color images, in operation 618.

One or more errors occurring are corrected, e.g., for when the stereo color cameras and the stereo depth cameras capture image data in different directions, in operation 620.

One or more color errors between color images are corrected for, e.g., which occur due to one or more features of each of the stereo color cameras, in operation 622.

Corrected depth maps respectively corresponding to the color images are generated, e.g., based on both disparity information associated with a disparity between the color images and primary depth maps, in operation 624.

In an embodiment, the primary depth maps may be generated respectively from the depth images, and secondary depth maps respectively corresponding to the color images may be generated based on the disparity information. The corrected depth maps may be generated by weighted-averaging the primary depth maps and the secondary depth maps respectively corresponding to the color images.

In an embodiment, in the generating of the corrected depth maps, the primary depth maps may be generated respectively from depth images, and information associated with the primary depth map may be used as a factor to calculate a disparity distance between the color images when stereo-matching of the color images is performed to generate the corrected depth maps.

The 3D image generating system generates a 3D image file including the color images and the corrected depth maps in operation 626. In an embodiment, the 3D image file may be configured as illustrated in FIG. 5.

A 3D image displaying method for a multi-view image will be described below with reference to FIG. 1. Referring to FIG. 1, a 3D image file may be received as a transmitted bitstream or obtained from a memory included in the 3D image displaying system 120 of FIG. 1, and decoded by the 3D image file decoder 121. An example of the 3D image file is shown in FIG. 5, and in an embodiment the 3D image file is generated by any above embodiment generating the 3D image file. A stereoscopic image may be generated by a stereoscopic scheme by the stereoscopic outputting unit. The stereoscopic scheme may be classified into a polarizing glasses scheme and a liquid crystal shutter glasses scheme, as indicated above. The multi-view image generating unit may generate multi-view images from the decoded 3D image file, and the autostereoscopic outputting unit may output the multi-view images by an autostereoscopic scheme. In an embodiment, the autostereoscopic outputting unit 124 of FIG. 1 may accordingly include a lenticular lens, a parallax barrier, and/or parallax illumination, and the like, as indicated above, depending on embodiment and the corresponding autostereoscopic scheme implemented.

One or more embodiments may provide a multi-view 3D image with high quality by merging depth maps generated respectively from depth images and disparity information associated with a disparity between color images when generating corrected depth maps to be used for displaying the multi-view 3D image, through a corresponding system and/or method.

Accordingly, one or more embodiments relate to a three-dimensional (3D) image generating and/or displaying system and method that may obtain depth information to generate a multi-view image, while capturing a 3D image, and a 3D image displaying system and method accommodating the generated multi-view image.

One or more embodiments may include a three-dimensional (3D) image generating system for a multi-view image, the system including stereo color cameras to capture stereo color images for a 3D image, stereo depth cameras to capture depth images of areas same as areas photographed by the stereo color cameras, a mapping unit to map the captured depth images with respective corresponding color images, of the captured color images, and a depth merging unit to generate corrected depth maps respectively corresponding to the captured color images, based on both disparity information associated with a disparity between the captured color images and primary depth maps respectively generated by the mapping of the mapping unit from the captured depth images.

In addition to the above, the system may include a 3D image file encoder to encode the generated 3D image file to be decodable for stereoscopic and autostereoscopic displaying schemes, the file including a header, a first color image of the captured color images, a second color image of the captured color images, a first corrected depth map of the corrected depth maps, a second corrected depth map of the corrected depth maps, a first confidence map of the generated confidence maps, and a second confidence map of the generated confidence maps.

The system may further include a 3D image file encoder to encode generated 3D image data as a bitstream or 3D image file with image data decodable for stereoscopic and autostereoscopic displaying schemes, the file including a header, a first color image of the captured color images, a second color image of the captured color images, a first corrected depth map of the corrected depth maps, and a second corrected depth map of the corrected depth maps. The system may further include a displaying unit to receive the bitstream or 3D image file and selectively display 3D image data represented in the bitstream or 3D image file through at least one of a stereoscopic and autostereoscopic displaying schemes.

One or more embodiments may include a three-dimensional (3D) image generating method for a multi-view image, the method including receiving color images and depth images respectively captured from stereo color cameras and stereo depth cameras, mapping the captured depth images with respective corresponding color images, of the captured color images, and generating corrected depth maps respectively corresponding to the captured color images, based on both disparity information associated with a disparity between the captured color images and primary depth maps respectively generated from the mapping of the captured depth images.

In addition to the above, the method may include capturing the color images and depth images by the stereo color cameras and stereo depth cameras.

The method may further include encoding the generated 3D image file to be decodable for stereoscopic and autostereoscopic displaying schemes, the file including a header, a first color image of the captured color images, a second color image of the captured color images, a first corrected depth map of the corrected depth maps, a second corrected depth map of the corrected depth maps, a first confidence map of the generated confidence maps, and a second confidence map of the generated confidence maps.

The method may further include encoding the generated 3D image data as a bitstream or 3D image file with image data decodable for stereoscopic and autostereoscopic displaying schemes, the file including a header, a first color image of the captured color images, a second color image of the captured color images, a first corrected depth map of the corrected depth maps, and a second corrected depth map of the corrected depth maps, and still further include decoding the bitstream or 3D image file and selectively displaying decoded 3D image data represented in the bitstream or 3D image file through at least one of a stereoscopic and autostereoscopic displaying schemes.

In addition to the above, one or more embodiments may include a three-dimensional (3D) image generating system for a multi-view image, the system including a 3D image decoder to decode 3D image data including color images and depth images from a received 3D image file and/or a bitstream representing captured color images and corrected depth maps, with the 3D image file and bitstream having a configuration equal to the bitstream and 3D image file encoded, including the generation of the corrected depth maps, according to a depth map correction method and encoding method embodiment, and a displaying unit to selectively display the decoded 3D image data according to a stereoscopic and autostereoscopic displaying scheme.

The system may further include a multi-view image generating unit to generate a multi-view image from plural decoded color images and plural decoded depth images from the 3D data.

In one or more embodiments, any apparatus, system, and unit descriptions herein include one or more hardware devices or hardware processing elements. For example, in one or more embodiments, any described apparatus, system, and unit may further include one or more desirable memories, and any desired hardware input/output transmission devices. Further, the term apparatus should be considered synonymous with elements of a physical system, not limited to a single device or enclosure or all described elements embodied in single respective enclosures in all embodiments, but rather, depending on embodiment, is open to being embodied together or separately in differing enclosures and/or locations through differing hardware elements.

In addition to the above described embodiments, embodiments can also be implemented through computer readable code/instructions in/on a non-transitory medium, e.g., a computer readable medium, to control at least one processing device, such as a processor or computer, to implement any above described embodiment. The medium can correspond to any defined, measurable, and tangible structure permitting the storing and/or transmission of the computer readable code.

The media may also include, e.g., in combination with the computer readable code, data files, data structures, and the like. One or more embodiments of computer-readable media include: magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Computer readable code may include both machine code, such as produced by a compiler, and files containing higher level code that may be executed by the computer using an interpreter, for example. The media may also be any defined, measurable, and tangible distributed network, so that the computer readable code is stored and executed in a distributed fashion. Still further, as only an example, the processing element could include a processor or a computer processor, and processing elements may be distributed and/or included in a single device.

The computer-readable media may also be embodied in at least one application specific integrated circuit (ASIC) or Field Programmable Gate Array (FPGA), as only examples, which execute (processes like a processor) program instructions.

While aspects of the present invention has been particularly shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments. Suitable results may equally be achieved if the described techniques are performed in a different order and/or if components in a described system, architecture, device, or circuit are combined in a different manner and/or replaced or supplemented by other components or their equivalents.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. A three-dimensional (3D) image generating system for a multi-view image, the system comprising:
stereo color cameras to capture stereo color images for a 3D image;
stereo depth cameras to capture depth images of areas same as areas photographed by the stereo color cameras;
a mapping unit to map the captured depth images with respective corresponding color images, of the captured color images; and
a depth merging unit to generate corrected depth maps respectively corresponding to the captured color images, based on both disparity information associated with a disparity between the captured color images and primary depth maps respectively generated by the mapping of the mapping unit from the captured depth images.

2. The system of claim 1, wherein the depth merging unit comprises:
a first depth measuring unit to generate the primary depth maps respectively from the captured depth images;
a second depth measuring unit to generate secondary depth maps respectively corresponding to the captured color images, based on the disparity information; and
a weighted-average calculator to generate the corrected depth maps by weighted-averaging, using a predetermined weight, the primary depth maps and the secondary depth maps respectively corresponding to the captured color images.

3. The system of claim 1, wherein the depth merging unit comprises:
a first depth measuring unit to generate the primary depth maps respectively from the captured depth images; and
a second depth measuring unit to use information associated with the primary depth maps as a factor to calculate a disparity distance between the captured color images when stereo-matching of the captured color images is performed to generate the corrected depth maps.

4. The system of claim 1, further comprising:
a synchronizing unit to set the stereo color cameras to be synchronized with the stereo depth cameras.

5. The system of claim 1, further comprising:
a camera setting unit to determine a feature of each of the stereo color cameras and the stereo depth cameras, to set the stereo color cameras and the stereo depth cameras to respectively capture the color images and the depth images with a same size, and to set the stereo depth cameras to respectively capture same respective areas as areas captured by respective corresponding stereo color cameras.

6. The system of claim 1, further comprising:
a distortion correcting unit to correct a distortion that occurs in the captured color images and the captured depth images due to a feature of each of the stereo color cameras and the stereo depth cameras.

7. The system of claim 1, further comprising:
a stereo correcting unit to correct an error that occurs when the stereo color cameras and the stereo depth cameras perform capturing in different directions.

8. The system of claim 1, further comprising:
a color correcting unit to correct a color error in the captured color images, which occurs due to a feature of each of the stereo color cameras being different.

9. The system of claim 1, further comprising:
a 3D image file generating unit to generate a 3D image file including the captured color images and the corrected depth maps.

10. The system of claim 9, further comprising:
generating confidence maps to indicate respective confidences of the corrected depth maps.

11. A three-dimensional (3D) image generating method for a multi-view image, the method comprising:
receiving color images and depth images respectively captured from stereo color cameras and stereo depth cameras;
mapping the captured depth images with respective corresponding color images, of the captured color images; and
generating corrected depth maps respectively corresponding to the captured color images, based on both disparity information associated with a disparity between the captured color images and primary depth maps respectively generated from the mapping of the captured depth images.

12. The method of claim 11, wherein the generating of the corrected depth maps comprises:
generating the primary depth maps respectively from the captured depth images;
generating secondary depth maps respectively corresponding to the captured color images, based on the disparity information; and
generating the corrected depth maps by weighted-averaging, using a predetermined weight, the primary depth maps and the secondary depth maps respectively corresponding to the captured color images.

13. The method of claim 11, wherein the generating of the corrected depth maps comprises:
generating the primary depth maps respectively from the captured depth images; and
generating the corrected depth maps, using information associated with the primary depth maps as a factor to calculate a disparity distance between the captured color images when stereo-matching of the captured color images is performed to generate the corrected depth maps.

14. The method of claim 11, further comprising:
setting the stereo color cameras to be synchronized with the stereo depth cameras.

15. The method of claim 11, further comprising:
determining a feature of each of the stereo color cameras and the stereo depth cameras, to set the stereo color cameras and the stereo depth cameras to capture the color images and the depth images with a same size, and to set the stereo depth cameras to respectively capture same respective areas as areas captured by respective corresponding stereo color cameras.

16. The method of claim 11, further comprising:
correcting a distortion that occurs in the captured color images and the captured depth images due to a feature of each of the stereo color cameras and the stereo depth cameras.

17. The method of claim 11, further comprising:
correcting an error that occurs when the stereo color cameras and the stereo depth camera perform capturing in different directions.

18. The method of claim 11, further comprising:
correcting a color error in captured color images, which occurs due to a feature of each of the stereo color cameras being different.

19. The method of claim 11, further comprising:
generating a 3D image file including the captured color images and the corrected depth maps.

20. The method of claim 19, wherein the 3D image file further includes confidence maps to indicate respective confidences of the corrected depth maps.
